(19) United States
(12) Patent Application Publication
(10) Pub. No.: US 2012/0306359 A1
(43) Pub. Date: Dec. 6, 2012

(54) ORGANIC ELECTROLUMINESCENT COMPONENT AND DISPLAY DEVICE

(75) Inventors: Ken Okamoto, Osaka (JP); Yoshimasa Fujita, Osaka (JP); Hidenori Ogata, Osaka (JP); Yuhki Kobayashi, Osaka (JP); Makoto Yamada, Osaka (JP); Katsumi Kondoh, Osaka (JP)

(73) Assignee: Sharp Kabushiki Kaisha, Osaka (JP)

(21) Appl. No.: 13/579,195

(22) PCT Filed: Oct. 28, 2010
(86) PCT No.: PCT/JP2010/069162

§ 371 Date: Aug. 15, 2012

(30) Foreign Application Priority Data
Feb. 17, 2010 (JP) 2010-032408

(51) Int. Cl. H05B 33/28

(52) U.S. Cl. 313/504

(57) ABSTRACT

An organic EL component (1) of the present invention includes a reflective anode (11), an organic light-emitting unit (12), a semitransparent cathode (13), and a color converting layer (15). The color converting layer (15) absorbs light emitted by the organic light-emitting unit (12) and having a first color, and emits converted light having a second color different from the first color. The semitransparent cathode (13) has a film thickness of not less than 20 nm and not greater than 30 nm, and efficiently reflects, toward a light extraction side, light emitted from the color converting layer (15).

### TECHNICAL FIELD

The present invention relates to an organic electroluminescent component and a display device including the same.

### BACKGROUND ART

Recent years have witnessed development of an organic EL (electroluminescence) display as a display device to replace a liquid crystal display device. An organic EL section, which is of a self-light-emitting type, allows a wide viewing angle and high visibility. Further, since it is a full solid-state component in the shape of a thin film, an organic EL section has been drawing attention in terms of space saving, portability and the like.

Under such circumstances, there is a demand for improvement in luminous efficiency of an organic EL component. A known method for such improvement is a method of using a microresonator structure to efficiently extract light from an organic light-emitting layer of the organic EL component.

FIG. 7 is a diagram schematically illustrating an organic EL component having a microresonator structure. FIG. 7 illustrates an organic light-emitting unit 102 that includes an organic light-emitting layer and that generates light, which is repeatedly reflected between a reflective electrode 101 and a transflective electrode 103. This causes only light having an identical wavelength to be emitted from the side of the transflective electrode 103, and consequently causes light to be high in intensity at a particular wavelength and to be emitted with directivity.

In the case where organic EL is used for a color display, such a color display typically includes organic EL components provided in correspondence with the respective ones of the three primary colors (RGB). Organic EL components can be provided respectively for R, G, and B by a method such as a fluorescence conversion method, which uses a color converting layer that absorbs light emitted from a light-emitting layer and that emits light having a wavelength different from that of the absorbed light. Patent Literature 1, for example, discloses an organic EL component that uses a fluorescence conversion method in combination with the above microresonator structure.

The above color converting layer, however, causes light to be emitted isotropically, and thus unfortunately lets light to be emitted also on the side opposite to a light extraction direction, resulting in a light extraction loss. The following describes this phenomenon in detail with reference to FIGS. 8 and 9. FIGS. 8 and 9 are each a diagram illustrating how light is emitted from a color converting layer, and are each a view schematically illustrating an organic EL component including a color converting member. FIG. 8 illustrates an organic EL component having no microresonator structure, whereas FIG. 9 illustrates an organic EL component having a microresonator structure.

FIGS. 8 and 9 each illustrate an organic EL component including: a reflective electrode 101; an organic light-emitting unit 102; a translucent electrode 103 (or a transparent electrode 113); a sealing resin 104; a color converting layer 105; and a color filter 106. The color converting layer 105 absorbs light from the organic light-emitting unit 102 and emits light. The color converting layer 105 generates spatially isotropic light. This causes such light to include not only a component that is emitted toward a light extraction side (that is, the side on which the substrate 106 provided with a color filter is provided), but also a component that is emitted toward a backside (that is, the side on which the translucent electrode 103 is provided). This consequently reduces a proportion of the light which proportion is extracted to the outside of the organic EL component, and thus causes a light extraction loss.

The organic EL component illustrated in FIG. 8 causes light emitted by the organic light-emitting unit 102 to also be scattered isotropically. This causes a light extraction loss to be even larger.

Patent Literature 2, in view of the above problem, discloses a technique for efficiently extracting light converted by a color converting layer.

### CITATION LIST

### Patent Literature 1

Japanese Patent Application Publication, Tokukaihei, No. 6-283271 A (Publication Date: Oct. 7, 1994)

### Patent Literature 2

PCT International Publication WO2006/009039 (Publication Date: Jan. 26, 2006)

### SUMMARY OF INVENTION

### Technical Problem

As described above, an organic EL component that uses a color converting method tends to have large power consumption due to a light extraction loss. Improving light extraction efficiency of an organic EL component is an important issue.

Patent Literature 2 discloses an arrangement including: a light-emitting element that includes an organic light-emitting layer between a pair of electrodes; and a color converting layer provided on a side on which light from the light-emitting element is extracted, the arrangement (i) allowing reflectance of the light-emitting element to be high with respect to light emitted by the color converting layer and thereby (ii) improving efficiency in extracting light emitted by the color converting layer. The above reflectance is, however, adjusted by means of the optical distance between a first electrode and a second electrode both included in the light-emitting element. Thus, in the arrangement disclosed in Patent Literature 2, the optical distance may be set to be excessively large (for instance, in further consideration of a microresonator structure). In this case, it is difficult to achieve a preferable extraction efficiency. This indicates that the technique disclosed in Patent Literature 2 cannot suitably improve efficiency in extracting light of an organic EL component.

The present invention has been accomplished in view of the above problem. It is an object of the present invention to provide (i) an organic EL component having a suitably improved light extraction efficiency and (ii) a display device including that organic EL component.

### Solution to Problem

In order to solve the above problem, an organic electroluminescent component (organic EL component) of the present invention includes: a pair of electrodes one of which is a translucent electrode; an organic light-emitting unit sandwiched between the pair of electrodes; and a color converting layer provided on a side of the translucent electrode which side is opposite to a side on which the organic light-emitting unit is provided, such that the translucent electrode is sandwiched between the color converting layer and the organic light-emitting unit, the color converting layer (i) absorbing light emitted by the organic light-emitting unit and having a first color and (ii) emitting converted light having a second color different from the first color, the translucent electrode including a metal compound and having a film thickness of not less than 20 nm and not greater than 30 nm.

According to the above arrangement, the color converting layer (i) absorbs light emitted by the organic light-emitting unit and having a first color and (ii) isotropically emits converted light having a second color different from the first color. The light emitted by the color converting layer contains a portion that travels in a direction opposite to the light extraction direction, the portion reaching a translucent electrode having a film thickness of not less than 20 nm and not greater than 30 nm.

The translucent electrode, which has the above film thickness, has an increased reflectance with respect to the light emitted by the color converting layer. Thus, the portion of the converted light which portion, after being emitted by the color converting layer, has reached the translucent electrode is efficiently reflected by the translucent electrode toward the light extraction direction.

The organic EL component of the present invention can consequently reduce a loss caused in extracting light emitted by a color converting layer, and suitably improve efficiency in light extraction as compared to conventional art.

### Advantageous Effects of Invention

An organic EL component of the present invention includes: a pair of electrodes one of which is a translucent electrode; an organic light-emitting unit sandwiched between the pair of electrodes; and a color converting layer provided on a side of the translucent electrode which side is opposite to a side on which the organic light-emitting unit is provided, such that the translucent electrode is sandwiched between the color converting layer and the organic light-emitting unit, the color converting layer (i) absorbing light emitted by the organic light-emitting unit and having a first color and (ii) emitting converted light having a second color different from the first color, the translucent electrode including a metal compound and having a film thickness of not less than 20 nm and not greater than 30 nm. This arrangement allows the translucent electrode to efficiently reflect light emitted by the color converting layer and traveling in a direction opposite to a light extraction direction. The above arrangement thus achieves the advantage of suitably improving luminous efficiency.

### BRIEF DESCRIPTION OF DRAWINGS

FIG. 1 is a cross-sectional view schematically illustrating an organic EL component for use in a display device of an embodiment of the present invention.

FIG. 2 is a graph indicative of the relation between the film thickness of a translucent electrode and an outside quantum yield.

FIG. 3 is a graph indicative of the relation, observed in an organic EL component including a green fluorescent substance layer, between the film thickness of a translucent electrode and an outside quantum yield.

FIG. 4 is a graph indicative of the relation, observed in an organic EL component including a red fluorescent substance layer, between the film thickness of a translucent electrode and an outside quantum yield.

FIG. 5 is a graph indicative of the relation between the wavelength of light and the reflectance of a translucent electrode.

FIG. 6 is a graph indicative of the relation between the wavelength of light and the transmittance of a translucent electrode.

FIG. 7 is a view schematically illustrating a microresonator structure.

FIG. 8 is a cross-sectional view schematically illustrating a conventional organic EL component.

FIG. 9 is a cross-sectional view schematically illustrating an organic EL component having a microresonator structure.

### DESCRIPTION OF EMBODIMENTS

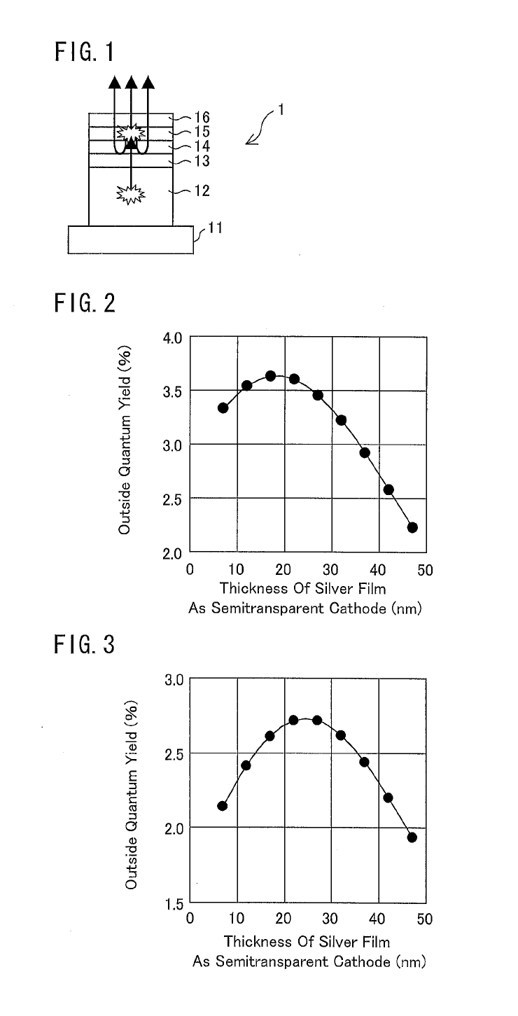

The description below deals with an organic EL component 1 of the present embodiment with reference to FIG. 1. FIG. 1 is a cross-sectional view schematically illustrating the organic EL component 1.

Arranging organic EL components 1 of the present embodiment can provide a display device. The description below deals mainly with an organic EL component 1 corresponding to a red pixel or green pixel of a display device. The present invention is, however, not limited to pixels of those colors. The organic EL component 1 may be, for example, a light-emitting element that emits light of a different color such as white, yellow, magenta, and cyan. Using such a light-emitting element allows a display device to (i) have low power consumption, (ii) display a larger number of primary colors, or (iii) have improved color reproducibility.

The organic EL component 1, as illustrated in FIG. 1, includes: a substrate (not shown); a first electrode 11; an organic light-emitting unit 12; a second electrode 13; a sealing film 14; a fluorescent substance layer (color converting layer) 15; and a CF (color filter)-provided substrate 16, all stacked on top of one another in that order.

The organic light-emitting unit 12 is a unit formed of organic layers including an organic light-emitting layer, and desirably emits blue or ultraviolet organic EL light in order to be used in a display device (display). This arrangement allows the color of high-energy light to be converted into green, red, or blue. The organic light-emitting unit 12 of the present embodiment emits blue light.

The organic EL component 1 may include (i) a TFT, an interlayer insulating film, and a planarizing film (not shown) stacked on top of one another in that order between the substrate and the first electrode 11 and (ii) a polarizing plate (not shown) on a light extraction side.

The organic EL component 1 has, between the first electrode 11 and the second electrode 13, an optical distance so adjusted as to form a microresonator structure.

The organic EL component 1, as illustrated in FIG. 1, has a structure of a top emission type. The present invention is, however, not limited to such a structure, and may have a structure of a bottom emission type.

The description below deals in greater detail with constituent members of the organic EL component 1 of the present embodiment and how it is formed. The present invention is, however, not limited by the description below.

(1. Substrate)

The substrate for use in the organic EL component 1 is an insulating substrate such as (i) an inorganic material substrate made of glass, quartz or the like, (ii) a plastic substrate made of polyethylene terephthalate, polycarbazole, polyimide or the like, or (iii) a ceramics substrate made of alumina or the like. The substrate can alternatively be (i) a metal substrate made of aluminum (Al), iron (Fe) or the like, (ii) a metal substrate, such as the above, that has a surface coated with an insulator made of silicon oxide (SiO₂), an organic insulating material or the like, or (iii) a metal substrate, such as the above, that has a surface which has been subjected to an insulating process by a method such as anodic oxidation.

The organic EL component preferably includes, among the above substrates, a plastic substrate or metal substrate because these substrates can each be, for example, curved or bent with no stress.

An organic EL component is commonly known to be degraded by, in particular, even a small amount of water. Thus, in the case where a plastic substrate is used as the above substrate, the organic EL component may be problematically degraded due to penetration of water. Further, it is also known that since an organic EL component has an extremely small film thickness of approximately 100 to 200 nm, a leak (short circuit) can easily occur in a current through a pixel section due to projection of the organic EL component. In view of this, the substrate on which an organic EL component is formed is, among others, more preferably (i) a plastic substrate coated with an inorganic material or (ii) a metal substrate coated with an inorganic insulating material. These substrates can each solve both of the above problems.

In the case where a TFT is provided on the substrate, the substrate is preferably a substrate that is not melted or deformed at a temperature of 500° C. or below. Since a typical metal substrate has a thermal expansion coefficient which is different from that of glass, it is difficult to form a TFT on a metal substrate with use of a conventional production device. However, in the case where (i) the above substrate is a metal substrate made of an iron-nickel alloy having a linear expansion coefficient of 1×10⁻⁵/° C. or below and (ii) that linear expansion coefficient is matched with that of glass, a TFT can be formed on a metal substrate inexpensively even with use of a conventional production device. Further, although a typical plastic substrate is only resistant to an extremely low temperature, a TFT can be formed on such a plastic substrate by means of transfer by first (i) forming a TFT on a glass substrate and then (ii) transferring the TFT onto the plastic substrate.

In the case where light emitted by the organic light-emitting unit 12 is extracted from the side opposite to the substrate side as in the present embodiment, the substrate is not limited in terms of transparency. In the case where light emitted by the organic light-emitting unit 12 is extracted from the substrate side, the substrate needs to be a transparent or semitransparent substrate.

(2. TFT)

The organic EL component preferably includes, on the above substrate, a TFT for switching and driving of the organic EL component 1. This arrangement allows the organic EL component 1 to be of an active driving type.

The TFT for use in the present embodiment can be formed of a publicly known material by a publicly known method to have a publicly known structure. The following describes a material, structure, and forming method for the TFT of the present embodiment. The present invention is, however, not limited by the description below.

The TFT includes an active layer that is made of a material such as (i) an inorganic semiconductor material, for example, amorphous silicon, polycrystalline silicon (polysilicon), microcrystalline silicon, or cadmium selenide, (ii) an oxide semiconductor material, for example, zinc oxide or indium oxide-gallium oxide-zinc oxide, and (iii) an organic semiconductor material, for example, a polythiophene derivative, a thiophene oligomer, a poly(p-phenylenevinylene) derivative, or naphthacene. The TFT has a structure of, for example, a staggered type, an inverted staggered type, a top-gate type, or a coplanar type.

The active layer included in the TFT can be formed by any of the various methods below.

A first method is a method of ion-doping an impurity into an amorphous silicon film formed by plasma-excited chemical vapor deposition (PECVD). A second method is a method of (i) forming amorphous silicon by low pressure chemical vapor deposition (LPCVD) involving use of silane (SiH₄) gas, (ii) crystallizing the amorphous silicon by solid-phase deposition into polysilicon, and then (iii) doping ions into the polysilicon by ion implantation. A third method is a method (low-temperature process) of (i) forming amorphous silicon by LPCVD involving use of Si₂H₆ gas or by PECVD involving use of SiH₄ gas, (ii) annealing the amorphous silicon with use of a laser such as an excimer laser to crystallize the amorphous silicon into polysilicon, and then (iii) doping ions. A fourth method is a method (high temperature process) of (i) forming a polysilicon layer by LPCVD or PECVD, (ii) thermally oxidizing the polysilicon layer at a temperature of 1000° C. or above to form a gate insulating film, (iii) forming a gate electrode of n+ polysilicon on the gate insulating film, and then (iv) doping ions. A fifth method is a method of forming an organic semiconductor material by a method such as inkjet printing. A sixth method is a method of forming a single-crystal film made of an organic semiconductor material.

The TFT for use in the present invention can include a gate insulating film that is formed of a publicly known material by a publicly known method. The gate insulating film is made of, for example, (i) SiO₂ formed by a method such as PECVD and LPCVD or (ii) SiO₂ formed by thermal oxidation of a polysilicon film.

The TFT for use in the present invention includes a signal electrode wire, a scanning electrode wire, a common electrode wire, a first drive electrode, and a second drive electrode, each of which is made of a publicly known material, for example, tantalum (Ta), aluminum (Al), or copper (Cu).

The TFT may be replaced by a metal-insulator-metal (MIM) diode.

(3. Interlayer Insulating Film)

The organic EL component preferably includes an interlayer insulating film on the substrate on which the TFT has been formed as above.

The interlayer insulating film for use in the present embodiment can be formed of a publicly known material by a publicly known method. The following describes a material and forming method for the interlayer insulating film for use in the present embodiment. The present invention is, however, not limited by the description below.

The interlayer insulating film can be made of a material such as (i) an inorganic material, for example, silicon oxide (SiO₂), silicon nitride (SiN or Si₂N₄), or tantalum oxide (TaO or Ta₂O₅), and (ii) an organic material, for example, an acrylic resin or a resist material. The interlayer insulating film can be formed by a method such as (i) a dry process, for example, chemical vapor deposition (CVD) or vacuum deposition, and (ii) a wet process, for example, spin coating. The interlayer insulating film can alternatively be patterned by a method such as photolithography as necessary.

The interlayer insulating film is more preferably a light-blocking insulating film that serves also to block light. Such a light-blocking insulating film can prevent a change caused in TFT property by external light incident on the TFT provided on the substrate. The light-blocking insulating film may be used in combination with the above insulating film.

The light-blocking interlayer insulating film is, for example, (i) a pigment or dye, such as phthalocyanine and quinacridone, that is dispersed in a polymer resin such as a polyimide, (ii) a color resist, (iii) a black matrix material, or (iv) an inorganic insulating material such as NiₓZn_{y}Fe₂O₄.

(4. Planarizing Film)

In the case where the TFT has been formed on the substrate, the substrate has an uneven surface. Such unevenness may cause, for example, defects in an organic EL section (for example, a defect in a pixel electrode, a defect in the organic EL layer, a breakage in a counter electrode, a short circuit between a pixel electrode and a counter electrode, and reduction in pressure resistance). To prevent such defects, the organic EL component preferably includes a planarizing film provided on the interlayer insulating film.

The planarizing film can be formed of a publicly known material by a publicly known method. The planarizing film can be made of a material such as (i) an inorganic material, for example, silicon oxide, silicon nitride, or tantalum oxide, and (ii) an organic material, for example, a polyimide, an acrylic resin, or a resist material. The planarizing film can be formed by a method such as (i) a dry process, for example, CVD or vacuum deposition, and (ii) a wet process, for example, spin coating.

The present invention is, however, not limited by such a material and forming method. The planarizing film may further have a single-layer structure or a multilayer structure.

(5. Organic EL)

The organic EL component 1 forms an organic EL structure with use of (i) the pair of electrodes (namely, the first electrode 11 and the second electrode 13) and (ii) the organic light-emitting unit 12 provided between the pair of electrodes.

(5-1. Organic Light-Emitting Unit 12)

The organic light-emitting unit 12, that is, an organic light-emitting unit, may have (i) a single-layer structure or (ii) a multilayer structure including an organic light-emitting layer and a charge transport layer. Specifically, the organic light-emitting unit 12 can have any of the structures below. The present invention is, however, not limited by such structures.

(1) Organic light-emitting layer

(2) Positive hole transport layer/organic light-emitting layer

(3) Organic light-emitting layer/electron transport layer

(4) Positive hole transport layer/organic light-emitting layer/electron transport layer

(5) Positive hole injection layer/positive hole transport layer/organic light-emitting layer/electron transport layer

(6) Positive hole injection layer/positive hole transport layer/organic light-emitting layer/electron transport layer/electron injection layer

(7) Positive hole injection layer/positive hole transport layer/organic light-emitting layer/positive hole blocking layer/electron transport layer

(8) Positive hole injection layer/positive hole transport layer/organic light-emitting layer/positive hole blocking layer/electron transport layer/electron injection layer

(9) Positive hole injection layer/positive hole transport layer/electron blocking layer/organic light-emitting layer/positive hole blocking layer/electron transport layer/electron injection layer

The organic light-emitting layer, the positive hole injection layer, the positive hole transport layer, the positive hole blocking layer, the electron blocking layer, the electron transport layer, and the electron injection layer may each have a single-layer structure or a multilayer structure. The following describes respective arrangements of those individual layers.

The description below first deals with the organic light-emitting layer. The organic light-emitting layer may be made of an organic light-emitting material mentioned below as an example, or may include a combination of a light-emitting dopant and a host material. The organic light-emitting unit may include any of, for example, a positive hole transport material, an electron transport material, and an additive (for example, a donor or an acceptor). The organic light-emitting unit may alternatively include any of those materials as dispersed in a high-molecular material (binding resin) or in an inorganic material. The organic light-emitting layer, to increase its luminous efficiency and life, preferably includes a light-emitting dopant as dispersed in a host material.

The organic light-emitting material can be a publicly known light-emitting material for organic EL use. Such a light-emitting material is divided into a low-molecular light-emitting material and a high-molecular light-emitting material. The following lists specific compounds as examples of the low-molecular and high-molecular light-emitting materials. The present invention is, however, not limited by the materials below.

The low-molecular organic light-emitting material is, for example, (i) an aromatic dimethylidene compound such as 4,4′-bis(2,2′-diphenylvinyl)-biphenyl (DPVBi), (ii) an oxadiazole compound such as 5-methyl-2-[2-[4-(5-methyl-2-benzoxazolyl)phenyl]vinyl]benz oxazole, (iii) a triazole derivative such as 3-(4-biphenylyl)-4-phenyl-5-t-butylphenyl-1,2,4-triazole (TAZ), (iv) a styrylbenzene compound such as 1,4-bis(2-methylstyryl)benzene, or (v) a fluorescence-emitting organic material such as a fluorenone derivative.

The high-molecular light-emitting material is, for example, (i) a polyphenylenevinylene derivative such as poly(2-decyloxy-1,4-phenylene) (DO-PPP) or (ii) a polyspiro derivative such as poly(9,9-dioctylfluorene) (PDAF).

The light-emitting material may be divided into a fluorescent material, a phosphorescent material and the like. To reduce power consumption, the light-emitting material is preferably a phosphorescent material, which is high in luminous efficiency.

The organic light-emitting layer can include a light-emitting dopant made of a publicly known dopant material for organic EL use. Such a dopant material is, for example, (i) a fluorescence-emitting material such as a styryl derivative or (ii) a phosphorescence-emitting organic metal complex such as bis[(4,6-difluorophenyl)-pyridinato-N,C2′]picolinate iridium (III) (FIrpic) and bis(4′,6′-difluorophenyl pyridinato)tetrakis(1-pyrazolyl)borate iridium (III) (FIr6).

The host material for a case involving a dopant can be a publicly known host material for organic EL use. Such a host material can be, for example, (i) the above low-molecular light-emitting material, (ii) the above high-molecular light-emitting material, (iii) a carbazole derivative such as 4,4′-bis(carb azole)biphenyl, 9,9-di(4-dicarbazole-benzyl)florene (CPF), 3,6-bis(triphenylsilyl)carbazole (mCP), and (PCF), (iv) an aniline derivative such as 4-(diphenylphosphoryl)-N,N-dipheny aniline (HM-A1), or (v) a florene derivative such as 1,3-bis(9-phenyl-9H-florene-9-yl)benzene (mDPFB) and 1,4-bis(9-phenyl-9H-florene-9-yl)benzene (pDPFB).

The following describes a charge injection/transport layer. The charge injection/transport layer is divided into charge injection layers (namely, the positive hole injection layer and the electron injection layer) and charge transport layers (namely, the positive hole transport layer and the electron transport layer) for the purpose of more efficiently carrying out (i) injection of electric charge (positive holes and electrons) from an electrode and (ii) transport (injection) thereof into an organic light-emitting layer.

The charge injection/transport layer may be made of a charge injection/transport material mentioned below as an example, and may also include any additive (for example, a donor or an acceptor). The charge injection/transport layer may alternatively include any of those materials as dispersed in a high-molecular material (binding resin) or in an inorganic material.

The charge injection/transport material can be a publicly known charge injection/transport material for organic EL use or for use in an organic photo conductor. Such a charge injection/transport material is divided into a positive hole injection/transport material and an electron injection/transport material. The following lists specific compounds as examples of the positive hole injection/transport material and the electron injection/transport material. The present invention is, however, not limited by the materials below.

First, the positive hole injection/positive hole transport material is, for example (i) an oxide such as vanadium oxide (V₂O₅) and molybdenum oxide (MoO₂), (ii) an inorganic p-type semiconductor material, (iii) a porphyrin compound, (iv) an aromatic tertiary amine compound such as N,N′-bis(3-methylphenyl)-N,N′-bis(phenyl)-benzidine (TPD) and N,N′-di(naphthalene-1-yl)-N,N′-dipheny-benzidine (NPD), (v) a low-molecular material such as a hydrazone compound, a quinacridone compound, and a styrilamine compound, or (vi) a high-molecular material such as polyaniline (PANI), polyaniline-camphor sulfonic acid (PANI-CSA), 3,4-polyethylene dioxy thiophene/polystyrene sulfonate (PEDOT/PSS), a poly(triphenylamine) derivative (Poly-TPD), polyvinylcarbazole (PVCz), poly(p-phenylenevinylene) (PPV), and poly(p-naphthalenevinylene) (PNV).

For more efficient injection and transport of positive holes from the anode, the positive hole injection layer is preferably made of a material that is lower in energy level of the highest occupied molecular orbital (HOMO) than the positive hole injection/transport material of which the positive hole transport layer is made. The positive hole transport layer is preferably made of a material that is higher in mobility of positive holes than the positive hole injection/transport material of which the positive hole injection layer is made.

To further facilitate injection and transport of positive holes, the positive hole injection/transport material is preferably doped with an acceptor. The acceptor can be made of a publicly known acceptor material for organic EL use. The following lists specific compounds as examples of the acceptor material. The present invention is, however, not limited by the materials below.

The acceptor material is, for example, (i) an inorganic material such as Au, Pt, W, Ir, POCl₃, AsF₆, Cl, Br, I, vanadium oxide (V₂O₅), and molybdenum oxide (MoO₂), (ii) a compound containing a cyano group, such as TCNQ (7,7,8,8,-tetracyanoquinodimethane), TCNQF₄ (tetrafluorotetracyanoquinodimethane), TCNE (tetracyanoethylene), HCNB (hexacyano butadiene), and DDQ (dicyclodicyano benzoquinone), (iii) a compound containing a nitro group, such as TNF (trinitro fluorenone) and DNF (dinitro fluorenone), or (iv) an organic material such as fluoranil, chloranil, and bromanil. To further increase carrier concentration effectively, the acceptor material is preferably, among the above compounds, a compound containing a cyano group, such as TCNQ, TCNQF₄, TCNE, HCNB, and DDQ.

The electron injection/electron transport material is, for example, (i) a low-molecular material such as an inorganic material serving as an n-type semiconductor, an oxadiazole derivative, a triazole derivative, a thiopyrazine dioxide derivative, a benzoquinone derivative, a naphthoquinone derivative, an anthraquinone derivative, a diphenoquinone derivative, a fluorenone derivative, and a benzodifuran derivative, or (ii) a high-molecular material such as poly(oxadiazole) (Poly-OXZ) and polystyrene derivative (PSS). The electron injection material, in particular, is, for example, (i) a fluoride such as lithium fluoride (LiF) and barium fluoride (BaF₂) or (ii) an oxide such as lithium oxide (Li₂O).

For more efficient injection and transport of electrons from the cathode, the electron injection layer is preferably made of a material that is higher in energy level of the lowest unoccupied molecular orbital (LUMO) than the electron injection/transport material of which the electron transport layer is made. The electron transport layer is preferably made of a material that is higher in mobility of electrons than the electron injection/transport material of which the electron injection layer is made.

To further facilitate injection and transport of electrons, the electron injection/transport material is preferably doped with a donor. The donor can be made of a publicly known donor material for organic EL use. The following lists specific compounds as examples of the donor material. The present invention is, however, not limited by the materials below.

The donor material is, for example, (i) an inorganic material such as an alkali metal, an alkali earth metal, a rare earth element, Al, Ag, Cu, and In, (ii) a compound containing an aromatic tertiary amine as its skeleton, such as an aniline, a phenylenediamine, a benzidine (for example, N,N,N′,N′-tetraphenyl benzidine, N,N′-bis-(3-methylphenyl)-N,N′-bis-(phenyl)-benzidine, and N,N′-di(naphthalene-1-yl)-N,N′-dipheny-benzidine), a triphenylamine (for example, triphenylamine, 4,4′4″-tris(N,N-dipheny-amino)-triphenylamine, 4,4′4″-tris(N-3-methylphenyl-N-phenyl-amino)-triphenylamine, and 4,4′4″-tris(N-(1-naphthyl)-N-phenyl-amino)-triphenylamine), and a triphenyldiamine (for example, N,N′-di-(4-methyl-phenyl)-N,N′-dipheny-1,4-phenylenediamine), (iii) a condensed polycyclic compound (which may optionally contain a substituent group) such as phenanthrene, pyrene, perylene, anthracene, tetracene, and pentacene, or (iv) an organic material such as a TTF (tetrathiafulvalene), dibenzofuran, phenothiazine, and carbazole. To further increase carrier concentration effectively, the donor material is preferably, among the above compounds, a compound containing an aromatic tertiary amine as its skeleton, a condensed polycyclic compound, or an alkali metal.

The organic light-emitting unit 12, which includes the light-emitting layer, the positive hole transport layer, the electron transport layer, the positive hole injection layer, and the electron injection layer all described above, can be formed by a method described below.

The organic light-emitting unit can be formed, with use of an application liquid for forming each organic EL layer which application liquid includes the above material dissolved and dispersed in a solvent, by a publicly known wet process such as (i) an application method (for example, spin coating, dipping, doctor blade method, discharge coating, and spray coating) and (ii) a printing method (for example, inkjet printing, relief printing, intaglio printing, screen printing, and micro gravure coating). Alternatively, the above material can be processed by, for example, (i) a publicly known dry process such as resistance heating vapor deposition, electron beam (EB) vapor deposition, molecular-beam epitaxy (MBE), sputtering, and organic vapor-phase deposition (OVPD) or (ii) a laser transfer method.

In the case where the organic light-emitting unit 12 is formed by a wet process, the application liquid for forming an organic EL layer may include an additive, such as a leveling agent and a viscosity adjusting agent, for use in adjusting a physical property of the application liquid. The organic EL layers may each be formed by a device of a bottom emission type or a device of a top emission type. Regardless of which device, it is preferably so designed that both electrodes are reflective electrodes and that organic EL light efficiently reaches the fluorescent substance layer 15 with use of a microcavity between the electrodes.

While a typical organic light-emitting unit has a film thickness of approximately 1 to 1000 nm, the organic light-emitting unit 12 preferably has a film thickness of 10 to 200 nm. If the film thickness is less than 10 nm, (i) it will be impossible to achieve normally required physical properties (namely, a charge injection property, a charge transport property, and a charge trapping property), and (ii) there may occur a pixel defect due to a foreign body such as dirt. If the film thickness exceeds 200 nm, the organic light-emitting unit 12 will include a resistance component that increases a driving voltage, resulting in an increase in power consumption.

(5-2. First Electrode 11 and Second Electrode 13)

The first electrode 11 is provided above the TFT with an interlayer insulating film and a planarizing film inserted therebetween. The second electrode 13 is provided on the organic light-emitting unit 12.

The first electrode 11 and the second electrode 13 function as a pair of an anode and a cathode for an organic EL component. Specifically, (i) in the case where the first electrode 11 serves as an anode, the second electrode 13 serves as a cathode, and (ii) in the case where the first electrode 11 serves as a cathode, the second electrode 13 serves as an anode. In the present embodiment, the first electrode 11 is the electrode provided on the substrate.

The first electrode 11 and the second electrode 13 can each be made of a publicly known electrode material. The following describes specific compounds and forming methods as examples. The present invention is, however, not limited by such materials and forming methods.

For more efficient injection of positive holes into the organic light-emitting unit 12, the anode is made of, for example, an electrode material that combines, with a metal material for increasing reflectance, a transparent electrode material having a work function of 4.5 eV or greater, such as (i) an oxide (ITO) including indium (In) and tin (Sn), (ii) an oxide (SnO₂) including tin (Sn), and (iii) an oxide (IZO) including indium (In) and zinc (Zn). The metal material is, for example, a metal such as gold (Au), platinum (Pt), nickel (Ni), silver (Ag), and aluminum (Al). The anode may alternatively be made of only a metal material.

For more efficient injection of electrons into the organic light-emitting unit 12, the cathode is made of, for example, an electrode material having a work function of 4.5 eV or less, such as (i) a metal, for example, lithium (Li), calcium (Ca), cerium (Ce), barium (Ba), and aluminum (Al), and (ii) an alloy containing any of the above metals, for example, a Mg:Ag alloy or a Li:Al alloy. Any of the above materials may alternatively be combined with (i) a highly reflective metal such as gold (Au), platinum (Pt), nickel (Ni), silver (Ag), and aluminum (Al) or (ii) a transparent electrode material.

The first electrode 11 and the second electrode 13 can each be formed of any of the above materials by a publicly known method such as EB vapor deposition, sputtering, ion plating, and resistance heating vapor deposition. The present invention is, however, not limited by such forming methods. The present invention may (i) pattern a formed electrode as necessary by photolithography or laser ablation, or may (ii) further use a shadow mask to directly form a patterned electrode.

The first electrode 11 and the second electrode 13 are separated from each other by an optical distance that is so adjusted as to form a microresonator structure (microcavity structure). In this case, it is preferable that (i) the first electrode 11 be a reflective electrode and (ii) the second electrode 13 be a translucent electrode.

In the case where the first electrode 11 and the second electrode 13 have formed a microresonator structure, that structure can focus light emission from the organic light-emitting unit 12 toward a frontal direction (that is, a light extraction direction). In other words, the above structure allows light emission from the organic light-emitting unit 12 to have directivity. This arrangement can thus (i) reduce a light emission loss caused by the light escaping in a direction different from the frontal direction, and (ii) increase luminous efficiency of the light. The above arrangement can consequently (i) cause light emission energy generated by the organic light-emitting unit to be propagated to the color converting layer more efficiently, and in turn (ii) increase frontal luminance of the display device of the present embodiment.

The use of the above microresonator structure also makes it possible to (i) adjust the emission spectrum of the organic light-emitting unit 12, and thus to (ii) adjust the emission spectrum so that it has a desired light emission peak wavelength and a half width. This arrangement can consequently control the emission spectrum of the organic light-emitting unit 12 so that the emission spectrum is a spectrum that can effectively excite a fluorescent substance in the color converting layer.

The present embodiment uses the second electrode 13 to serve as a reflection film for color converted light. Specifically, the second electrode 13 is arranged as described below to have an increased reflectance with respect to light emitted by the fluorescent substance layer 15.

First, the second electrode 13 can be made of, for example, (i) only a single metal compound or (ii) a combination of a metal compound and a transparent electrode material. The metal compound is preferably silver, a silver alloy, gold, or a gold alloy. Gold is known to be, although low in reflectance for light in the blue range, equivalent to silver in reflectance for light in the green and red ranges.

The second electrode 13, in the case where it is made of a metal compound, has a film thickness of not less than 20 nm and not greater than 30 nm, more preferably not less than 22 nm and not greater than 27 nm, or most preferably 25 nm.

With the above arrangement, the second electrode 13 can efficiently reflect, toward the light extraction side, light emitted from the fluorescent substance layer 15.

The first electrode 11, which is a reflective electrode, is preferably made of an electrode that is high in reflectance with respect to light. The reflective electrode is a reflective metal electrode made of, for example, aluminum, silver, gold, an aluminum-lithium alloy, an aluminum-neodymium alloy, or an aluminum-silicon alloy. The reflective electrode may alternatively be an electrode that combines a transparent electrode with the reflective metal electrode.

(5-3. Edge Cover)

The first electrode 11 described above preferably has an edge portion that is provided with an edge cover. Providing an edge cover can prevent a leak between the first electrode 11 and the second electrode 13.

The edge cover can be (i) formed of an insulating material by a publicly known method such as EB vapor deposition, sputtering, ion plating, and resistance heating vapor deposition and (ii) patterned by photolithography based on a publicly known dry method or wet method.

The edge cover can be made of a publicly known insulating material that transmits light, for example, SiO, SiON, SiN, SiOC, SiC, HfSiON, ZrO, HfO, or LaO. The edge cover preferably has a film thickness of 100 to 2000 nm. If the edge cover has a film thickness of less than 100 nm, no sufficient insulation will be provided, which causes a leak between the first electrode 11 and the second electrode 13. This in turn, for example, increases power consumption and/or prevents the organic EL component from emitting light. If the edge cover has a film thickness exceeding 2000 nm, such an edge cover may, for example, (i) require a long process time to be formed, with the result of decreased productivity, or (ii) break the second electrode 13.

The present invention is not limited by the above forming methods and materials.

The description below uses the term “organic EL substrate” to refer to a substrate formed by the above process to include the first electrode 11, the organic light-emitting unit 12, and the second electrode 13 (and the edge cover).

(6. Sealing Film 14)

The organic EL component includes a sealing film 14 on the second electrode 13. Providing the sealing film 14 can prevent oxygen, water and the like from entering the organic light-emitting unit 12 from the outside, and thus allows the light-emitting element to have a longer life.

The sealing film 14 can be formed of a publicly known sealing material by a publicly known sealing method. The sealing film of the present embodiment needs to be made of a light-transmitting material. The sealing film 14 can be formed by, for example, (i) applying resin onto the second electrode 13 by spin coating, ODF, or lamination, or (ii) combining a resin film with the second electrode. The sealing film 14 can alternatively be formed by first forming an inorganic film of SiO, SiON, SiN or the like on the second electrode 13 by a method such as plasma CVD, ion plating, ion beam method, and sputtering, and then (i) applying resin by spin coating, ODF, or lamination, or (ii) combining a resin film with the second electrode.

The organic light-emitting unit 12 may be sealed by using a sealing substrate for a substrate serving as the below-described CF-provided substrate 16. The sealing substrate may be made of a material, such as glass or metal, that contains sealed therein an inert gas such as nitrogen gas and argon gas. To reduce degradation, caused by water, of the organic light-emitting unit 12 effectively, the material of which the sealing substrate is made preferably contains, sealed therein, an inert gas that includes, for example, a moisture absorbent such as barium oxide.

The organic EL component 1 of the present embodiment can be prepared by, for example, combining, with the sealing film 14 inserted in-between, (i) a substrate (organic EL substrate) having an organic EL structure with (ii) the CF-provided substrate 16 (fluorescent substance substrate) on which the fluorescent substance layer 15 has been formed.

(7. Fluorescent Substance Layer 15)

The fluorescent substance layer 15 is provided on the sealing film 14. The fluorescent substance layer absorbs blue light emitted by the organic light-emitting unit 12, and emits, for example, red or green light. An organic EL component 1 to be used for a red pixel includes a red fluorescent substance layer as the fluorescent substance layer 15, and an organic EL component 1 to be used for a green pixel includes a green fluorescent substance layer as the fluorescent substance layer 15. An organic EL component to be used for a blue pixel includes no fluorescent substance layer 15.

The following describes materials and forming methods for the fluorescent substance layer 15.

The fluorescent substance layer 15 may (i) be made of only a fluorescent substance material mentioned below as an example, or include any additive and/or the like, and may (ii) include any of those materials as dispersed in a high-molecular material (binding resin) or in an inorganic material. The fluorescent substance layer preferably includes a black matrix formed between individual fluorescent substance layers.

The fluorescent substance layer 15 can be made of a publicly known fluorescent substance material. Such a fluorescent substance material is divided into an organic fluorescent substance material and an inorganic fluorescent substance material. The following lists specific compounds as examples of those fluorescent substance materials. The present invention is, however, not limited by the materials below.

The description below first deals with the organic fluorescent substance material. For use in a red fluorescent substance layer, the fluorescent substance material is, for example, (i) a cyanin pigment such as 4-dicyano methylene-2-methyl-6-(p-dimethylamino styllyl)-4H-pyrane, (ii) a pyridine pigment such as 1-ethyl-2-[4-(p-dimethylamino phenyl)-1,3-butadienyl]-pyridinium-perchlorate, or (iii) a rhodamine pigment such as rhodamine B, rhodamine 6G, rhodamine 3B, rhodamine 101, rhodamine 110, basic violet 11, and sulforhodamine 101. For use in a green fluorescent substance layer, the fluorescent substance material is, for example, (i) a coumarin pigment such as 2,3,5,6-1H, 4H-tetrahydro-8-trifluo methyl quinolizine (9,9a, 1-gh) coumarin (coumarin 153), 3-(2′-benzothiazolyl)-7-diethylamino coumarin (coumarin 6), 3-(2′-benzoimidazolyl)-7-N,N-diethylamino coumarin (coumarin 7), or (ii) a naphthalimide pigment such as basic yellow 51, solvent yellow 11, and solvent yellow 116.

The following lists examples of the inorganic fluorescent substance material. For use in a red fluorescent substance layer, the fluorescent substance material is, for example, Y₂O₂S:Eu³⁺, YAlO₃:Eu³⁺, Ca₂Y₂(SiO₄)₆:Eu³⁺, LiY₉(SiO₄)₆O₂:Eu³⁺, YVO₄:Eu³⁺, CaS:Eu³⁺, Gd₂O₃:Eu³⁺, Gd₂O₂S:Eu³⁺, Y(P,V)O₄:Eu³⁺, Mg₄GeO_{5.5}F:Mn⁴⁺, Mg₄GeO₆:Mn⁴⁺, K₅Eu_{2.5}(WO₄)_{6.25}, Na₅Eu_{2.5}(WO₄)_{6.25}, K₅Eu_{2.5}(MoO₄)_{6.25}, or Na₅Eu_{2.5}(MoO₄)_{6.25}. For use in a green fluorescent substance layer, the fluorescent substance material is, for example, (BaMg)Al₁₆O₂₇:Eu²⁺, Mn²⁺, Sr₄Al₁₄O₂₅:Eu²⁺, (SrBa)Al₁₂Si₂O₈:Eu²⁺, (BaMg)₂SiO₄:Eu²⁺, Y₂SiO₅:Ce₃₊, Tb³⁺, Sr₂P₂O₇—Sr₂B₂O₅:Eu²⁺, (BaCaMg)₅(PO₄)₃Cl:Eu²⁺, Sr₂Si₃O₈-2SrCl₂:Eu²⁺, Zr₂SiO₄, MgAl₁₁O₁₉:Ce³⁺, Tb³⁺, Ba₂SiO₄:Eu²⁺, Sr₂SiO₄:Eu²⁺, or (BaSr)SiO₄:Eu²⁺. The inorganic fluorescent substance material is preferably subjected to a surface reforming treatment as necessary by, for example, (i) a method involving a chemical treatment that uses a silane coupling agent or the like, (ii) a method involving a physical treatment that adds, for example, microparticles on a sub-micron order, or (iii) a method combining the above two methods. The above fluorescent substance material is, for the sake of its stability, preferably an inorganic fluorescent substance material in consideration of, for example, degradation due to excitation light and degradation due to light emission. In the case where the inorganic fluorescent substance material is used, that material preferably has an average particle size (d50) of 0.5 to 50 μm. If the average particle size is less than 0.5 μm, the fluorescent substance will have a significantly lower luminous efficiency. If the average particle size exceeds 50 μm, it will be extremely difficult to form a flat film. This will unfortunately allow a gap to be formed between the fluorescent substance layer 15 and the organic EL substrate. Specifically, such a gap (refractive index: 1.0) between the organic EL substrate (refractive index: approximately 1.7) and the inorganic fluorescent substance layer 15 (refractive index: approximately 2.3) may (i) prevent light emitted from the organic EL substrate from efficiently reaching the fluorescent substance layer 15 and thus (ii) decrease the luminous efficiency of the fluorescent substance layer 15.

In the case where the above polymer resin is a photosensitive resin, it can be patterned by photolithography.

The photosensitive resin can be one of or a mixture of a plurality of photosensitive resins (that is, photo-curable resist materials) each containing a reactive vinyl group, such as acrylic acid resin, methacrylic acid resin, polyvinyl cinnamate resin and vulcanite resin.

The fluorescent substance layer 15 can be formed, with use of an application liquid for forming a fluorescent substance layer which application liquid includes the above fluorescent substance material (pigment) and the resin material both dissolved and dispersed in a solvent, by a method such as (i) a publicly known wet process or dry process or (ii) a laser transfer method. The publicly known wet process includes (i) an application method (for example, spin coating, dipping, doctor blade method, discharge coating, and spray coating) and (ii) a printing method (for example, inkjet printing, relief printing, intaglio printing, screen printing, and micro gravure coating). The publicly known dry process includes resistance heating vapor deposition, electron beam (EB) vapor deposition, molecular-beam epitaxy (MBE), sputtering, and organic vapor-phase deposition (OVPD).

The fluorescent substance layer 15 typically has a film thickness of approximately 100 nm to 100 μm, but preferably has a film thickness of 1 to 100 μm. If the red fluorescent substance layer or the green fluorescent substance layer has a film thickness of less than 100 nm, such a fluorescent substance layer will be unable to sufficiently absorb blue light emitted by the organic light-emitting unit 12. This will problematically decrease the luminous efficiency of the organic EL component 1 and/or cause transmitted blue light to be mixed with converted light, resulting in a decrease in color purity. The fluorescent substance layer preferably has a film thickness of not less than 1 μm in order to (i) further absorb blue light emitted by the organic light-emitting unit 12 and to (ii) reduce transmitted blue light to a degree that does not allow an adverse effect to be caused on color purity. On the other hand, even if the red fluorescent substance layer or the green fluorescent substance layer has a film thickness exceeding 100 μm, such a film thickness will not contribute to an increase in the luminous efficiency of the organic EL component 1 because even a film thickness smaller than that can sufficiently absorb blue light emitted by the organic light-emitting unit 12. Such a large film thickness will merely consume the material and thus result in an increase in material costs.

The substrate (fluorescent substance layer substrate) on which the fluorescent substance layer 15 has been formed preferably has a surface that is planarized by, for example, the planarizing film described above. This arrangement can (i) prevent a gap from being formed between the organic EL substrate and the fluorescent substance layer 15 when the fluorescent substance layer substrate is combined with the organic EL substrate, and also (ii) increase adherence between the fluorescent substance layer substrate and the organic EL substrate.

In a case that involves a display device which includes, in addition to red, green, and blue-light-emitting elements, a plurality of primary color elements of white, yellow, magenta, cyan and the like, such a display device may include a fluorescent substance layer 15 corresponding to each color. This arrangement can, for example, reduce power consumption and widen the color reproduction range. Fluorescent substance layers 15 corresponding respectively to a plurality of primary colors can be easily formed by photolithography involving a resist, a printing method, or a wet forming method rather than, for example, separate painting involving a mask.

(8. CF-Provided Substrate 16)

The organic EL component 1 of the present embodiment is preferably provided with a CF-provided substrate 16 on the light extraction side. The color filter can be a conventional color filter.

The color filter of the CF-provided substrate 16 can (i) increase color purity (for example, for red, green, or blue) of the organic EL component, and (ii) widen the color reproduction range of a display device including the organic EL component 1. A red color filter and a green color filter each absorb a blue color component and an ultraviolet component in external light, and can thus reduce or prevent light emission, caused by external light, of a fluorescent substance layer. Thus, in a display device including the organic EL component 1, the provision of the CF-provided substrate 16 can reduce or prevent a decrease in contrast of the display device.

(9. Polarizing Plate)

The organic EL component 1 of the present embodiment is preferably provided with a polarizing plate on the light extraction side. The polarizing plate can be a combination of a conventional linear polarizing plate and a λ/4 plate. The provision of the polarizing plate can prevent, for example, (i) the first electrode 11 and the second electrode 13 from reflecting external light and (ii) the substrate or the sealing substrate from reflecting external light by its surface. Thus, in a display device including the organic EL component 1, the provision of the polarizing plate can improve contrast of the display device.

(Display Device)

The use of the organic EL component 1 of the present embodiment makes it possible to produce a highly efficient display device. In the case of, for example, producing a color display device, such a display device can include (i) as each of a red-light-emitting element and a green-light-emitting element, an organic EL component 1 arranged as described above and (ii) as a blue-light-emitting element, a light-emitting element arranged as described above, except that it includes no fluorescent substance layer 15.

In the above case, the blue-light-emitting element preferably includes a film thickness adjusting layer in place of the fluorescent substance layer 15. The film thickness adjusting layer can be made of (i) an inorganic material including silicon oxide, silicon nitride, or tantalum oxide or (ii) an organic material including a polyimide, an acrylic resin, or a resist material.

The embodiment above describes a case involving an organic light-emitting unit 12 that emits blue light. The present invention is, however, not limited to such an arrangement. The present invention can produce (i) an organic EL component including an organic light-emitting unit that emits ultraviolet light and (ii) a display device including that organic EL component. Such a display device is a highly efficient display device similar to that of the embodiment above, and is a preferable display device because it can have an identical viewing angle characteristic for respective light-emitting elements of blue, red, and green.

(Other)

The present invention is not limited to the description of the embodiment above, but may be altered in various ways by a skilled person within the scope of the claims. Any embodiment based on a combination of technical means appropriately altered within the scope of the claims is also encompassed in the technical scope of the present invention.

As described above, an organic electroluminescent component (organic EL component) of the present invention includes: a pair of electrodes one of which is a translucent electrode; an organic light-emitting unit sandwiched between the pair of electrodes; and a color converting layer provided on a side of the translucent electrode which side is opposite to a side on which the organic light-emitting unit is provided, such that the translucent electrode is sandwiched between the color converting layer and the organic light-emitting unit, the color converting layer (i) absorbing light emitted by the organic light-emitting unit and having a first color and (ii) emitting converted light having a second color different from the first color, the translucent electrode including a metal compound and having a film thickness of not less than 20 nm and not greater than 30 nm.

The organic EL component of the present invention may preferably be arranged such that the pair of electrodes forms a microresonator structure.

The above arrangement allows light emitted by the organic light-emitting unit to (i) have directivity due to a microresonator structure and thus (ii) be high in intensity at a particular wavelength. The above arrangement, in other words, also improves efficiency in extracting light of the organic light-emitting unit, and can consequently further improve luminous efficiency of the organic EL component of the present invention.

The organic EL component of the present invention may preferably be arranged such that the translucent electrode has a film thickness of not less than 22 nm and not greater than 27 nm.

With the above arrangement, the reflectance of the translucent electrode with respect to converted light emitted by the color converting layer can be adjusted to a more preferable value.

The organic EL component of the present invention may preferably be arranged such that the organic light-emitting unit emits blue or ultraviolet light; and the translucent electrode has a reflectance of (i) not greater than 60% with respect to the blue or ultraviolet light and (ii) not less than 60% with respect to the converted light emitted by the color converting layer. Further, the display device of the present invention may preferably be arranged such that the translucent electrode has a transmittance of not less than 25% with respect to the blue or ultraviolet light.

The above arrangement allows (i) the blue or ultraviolet light emitted by the organic light-emitting unit to efficiently pass through the translucent electrode and reach the color converting layer, and (ii) converted light emitted by the color converting layer to be reflected by the translucent electrode efficiently. The above arrangement consequently enables production of an organic EL component having higher light extraction efficiency.

The organic electroluminescent component of the present invention may further preferably be arranged such that the organic light-emitting unit emits ultraviolet light; and the translucent electrode has a reflectance of (i) not greater than 50% with respect to the ultraviolet light and (ii) not less than 50% with respect to the converted light emitted by the color converting layer. Further, the display device of the present invention may preferably be arranged such that the translucent electrode has a transmittance of not less than 40% with respect to the ultraviolet light.

The organic EL component of the present invention may preferably be arranged such that the metal compound included in the translucent electrode is one of silver, a silver alloy, gold, and a gold alloy.

The above arrangement makes it possible to prepare a translucent electrode that is preferable in terms of the reflectance.

A display device of the present invention preferably includes any of the above organic EL components. This arrangement allows production of a display device having high luminous efficiency.

A display device of the present invention includes: a plurality of arranged light-emitting elements including a red-light-emitting element, a green-light-emitting element, and a blue-light-emitting element, the red-light-emitting element and the green-light-emitting element each including the above organic EL component, the blue-light-emitting element including a first organic electroluminescent component that is identical to the above organic EL component except that the color converting layer is absent in the first organic electroluminescent component, the organic light-emitting unit in each of the plurality of arranged light-emitting elements emitting blue light, the translucent electrode in¥ each of the red-light-emitting element and the green-light-emitting element having a reflectance with respect to the converted light which reflectance is higher than a reflectance of the translucent electrode in the blue-light-emitting element with respect to the converted light.

With the above arrangement, the red-light-emitting element and the green-light-emitting element, each of which includes a color converting layer, each include a translucent electrode having a reflectance with respect to color converted light which reflectance is higher than that of the blue-light-emitting element, which includes no color converting layer. The above arrangement thus, in the red-light-emitting element and the green-light-emitting element, reduces a loss in extraction of light emitted by the color converting layer and improves efficiency in light extraction. The above arrangement consequently allows production of a display device having higher luminous efficiency.

The display device of the present invention may preferably be arranged such that the translucent electrode in the blue-light-emitting element has a transmittance with respect to the light emitted by the color converting layer which transmittance is higher than a transmittance of the translucent electrode in each of the red-light-emitting element and the green-light-emitting element with respect to the light emitted by the color converting layer.

With the above arrangement, the translucent electrode in the blue-light-emitting element allows blue light emitted by the organic light-emitting unit to pass through itself, which in turn improves luminous efficiency of the blue-light-emitting element. The display device of the present invention can consequently have improved luminous efficiency for each light-emitting element.

The display device of the present invention may preferably be arranged such that the blue-light-emitting element includes a film thickness adjusting layer, the film thickness adjusting layer being provided on a side of the translucent electrode which side is opposite to a side on which the organic light-emitting unit is provided, such that the translucent electrode is sandwiched between the film thickness adjusting layer and the organic light-emitting unit, the film thickness adjusting layer including either (i) an inorganic material including silicon oxide, silicon nitride, or tantalum oxide or (ii) an organic material including a polyimide, an acrylic resin, or a resist material.

The above arrangement allows the blue-light-emitting element to have a viewing angle characteristic that is close to the respective viewing angle characteristics of the optical light-emitting elements other then the blue-light-emitting element. The above arrangement consequently allows suitable production of the display device of the present invention.

A display device of the present invention may include: a plurality of arranged light-emitting elements including a red-light-emitting element, a green-light-emitting element, and a blue-light-emitting element, the red-light-emitting element, the green-light-emitting element, and the blue-light-emitting element each including the above organic electroluminescent component, the organic light-emitting unit in each of the plurality of arranged light-emitting elements emitting ultraviolet light.

The above arrangement allows the individual light-emitting elements to have an identical viewing angle characteristic, which in turn allows suitable production of the display device of the present invention.

The display device of the present invention may preferably be arranged such that the plurality of arranged light-emitting elements include, in addition to the red-light-emitting element, the blue-light-emitting element, and the green-light-emitting element, at least one of a white-light-emitting element, a yellow-light-emitting element, a magenta-light-emitting element, and a cyan-light-emitting element.

The above arrangement widens the color reproduction range and reduces power consumption. The color converting layer can be easily formed by photolithography involving a resist, a printing method, or a wet forming method rather than, for example, separate painting involving a mask.

### EXAMPLES

The description below deals in greater detail with the present invention on the basis of Examples. The present invention is, however, not limited by the Examples below.

### Examples 1 and 2

The present Examples prepared an organic EL component corresponding to a red pixel (Example 1) and an organic EL component corresponding to a green pixel (Example 2) each with various film thicknesses for a second electrode (translucent electrode).

The description below first deals with a method for preparing the respective organic EL components of Examples 1 and 2.

(Formation of Organic EL Substrate)

The present Examples formed, on a glass substrate having a thickness of 0.7 mm, a silver film with a film thickness of 100 nm by sputtering as a reflective electrode, and then formed, on that silver film, an indium tin oxide (ITO) film with a film thickness of 20 nm by sputtering. This operation formed a reflective electrode (anode) as a first electrode. The present Examples then patterned the reflective electrode by conventional photolithography into 90 stripes each having an electrode width of 2 mm.

The present Examples next formed, on the reflective electrode, a SiO₂ layer with a thickness of 200 nm by sputtering, and patterned the layer by conventional photolithography so that the layer would cover an edge portion of the reflective electrode. This operation formed an interlayer insulating film and a planarizing film. The interlayer insulating film was so structured that SiO₂ covered a part of the reflective electrode which part extended for 10 μm from the edge of each short side. The present Examples washed the product with water, and then carried out, with respect to the product, pure water ultrasonic washing for 10 minutes, acetone ultrasonic washing for 10 minutes, and isopropyl alcohol vapor washing for 5 minutes. The present Examples then dried the resulting product at 100° C. for 1 hour.

The present Examples next fixed a substrate to a substrate holder in an inline resistance heating vapor deposition device, and reduced the pressure inside the device to a vacuum of 1×10⁻⁴ Pa or less in order to form individual organic layers for an organic light-emitting unit.

The present Examples first, with use of 1,1-bis-di-4-tolylamino-phenyl-cyclohexane (TAPC) as a positive hole injection material, formed a positive hole injection layer with a film thickness of 100 nm by resistance heating vapor deposition.

The present Examples next, with use of N,N′-di-1-naphthyl-N,N′-dipheny-1,1′-biphenyl-1,1′-biphenyl-4,4′-diamine (NPD) as a positive hole transport material, formed a positive hole transport layer with a film thickness of nm by resistance heating vapor deposition.

The present Examples then formed a blue organic light-emitting layer (thickness: 30 nm) at a desired pixel position on the positive hole transport layer. The present Examples prepared this blue organic light-emitting layer by co-depositing 1,4-bis-triphenylsilyl-benzene (UGH-2) (host material) and bis[(4,6-difluorophenyl)-pyridinato-N,C2′]picolinate iridium (III) (FIrpic) (blue phosphorescence-emitting dopant) at respective vapor deposition speeds of 1.5 Å/sec and 0.2 Å/sec.

The present Examples next formed, with use of 2,9-dimethyl-4,7-dipheny-1,10-phenanthroline (BCP), a positive hole blocking layer (thickness: 10 nm) on the organic light-emitting layer.

The present Examples then formed, with use of tris(8-hydroxy quinoline) aluminum (Alq3), an electron transport layer (thickness: 30 nm) on the positive hole blocking layer.

The present Examples next formed, with use of lithium fluoride (LiF), an electron injection layer (thickness: 0.5 nm) on the electron transport layer.

The above process formed the individual organic layers for an organic light-emitting unit.

The present Examples then formed a translucent electrode as a second electrode. Specifically, the present Examples first fixed a substrate in a metal vapor deposition chamber, and aligned the substrate with a shadow mask for forming a translucent electrode. This shadow mask was a mask having openings for forming a translucent electrode, the openings being in the shape of stripes each having a width of 2 mm and extending in a direction at right angles to the stripes of the reflective electrode. The present Examples next co-deposited magnesium and silver on a surface of the organic light-emitting unit by vacuum deposition at respective vapor deposition speeds of 0.1 Å/sec and 0.9 Å/sec. This operation formed a desired pattern of magnesium silver (thickness: 1 nm). The present Examples further formed, on the magnesium silver, a desired pattern of silver (thickness: 7 to 47 nm) at a vapor deposition speed of 1 Å/sec. This silver pattern was intended to increase an interference effect and prevent a voltage drop caused in the second electrode by wiring resistance. This operation formed a second electrode 13.

The above arrangement allows for a microcavity effect (interference effect) between the reflective electrode and the semi-transmissive electrode, which makes it possible to increase the frontal luminance. The above arrangement thus allows light emission energy from the organic light-emitting unit to be propagated more efficiently with use of a fluorescent substance layer.

The above process prepared an organic EL substrate including an organic EL component.

The film thicknesses mentioned in the present specification can be measured with use of a stylus profilometer, an optical film thickness measuring system (three-dimensional surface roughness measuring instrument, ellipsometry).

(Formation of Fluorescent Substance Substrate)

The present Examples next formed, on respective CF-provided glass substrates each having a thickness of 0.7 mm, a fluorescent substance layer corresponding to a red pixel and a fluorescent substance layer corresponding to a green pixel. Specifically, the present Examples formed the fluorescent substance layers as described below.

To form a red fluorescent substance layer, the present Examples first added 15 g of ethanol and 0.22 g of γ-glycidoxypropyl triethoxysilane to 0.16 g of an aerosol having an average particle size of 5 nm, and stirred the mixture in an open system at room temperature for 1 hour. The present Examples then placed this mixture and 20 g of red fluorescent substance (pigment) K₅Eu_{2.5}(WO₄)_{6.25} in a mortar, and crushed and mixed them well. The present Examples next heated the resulting mixture in a 70° C. oven for 2 hours, and further heated the resulting mixture in a 120° C. oven for 2 hours. This operation produced K₅Eu_{2.5}(WO₄)_{6.25} having a reformed surface. The present Examples then added, to 10 g of the surface-reformed K₅Eu_{2.5}(WO₄)_{6.25}, 30 g of polyvinyl alcohol dissolved in a mixed solution (300 g) of water:dimethyl sulfoxide with the ratio of 1:1, and stirred the resulting mixture in a dispersing device. This operation prepared an application liquid for forming a red fluorescent substance layer. The present Examples applied the thus prepared application liquid for forming a red fluorescent substance layer at a red pixel position on the CF-provided glass substrate by screen printing so that the resulting layer would have a width of 3 mm. The present Examples next heated the substrate in a vacuum oven (conditions: 200° C. and 10 mmHg) for 4 hours to dry it. This operation formed a red fluorescent substance layer.

To form a green fluorescent substance layer, the present Examples first added 15 g of ethanol and 0.22 g of γ-glycidoxypropyl triethoxysilane to 0.16 g of an aerosol having an average particle size of 5 nm, and stirred the mixture in an open system at room temperature for 1 hour. The present Examples then placed this mixture and 20 g of green fluorescent substance (pigment) Ba₂SiO₄:Eu²⁺ in a mortar, and crushed and mixed them well. The present Examples next heated the resulting mixture in a 70° C. oven for 2 hours, and further heated the resulting mixture in a 120° C. oven for 2 hours. This operation produced Ba₂SiO₄:Eu²⁺ having a reformed surface. The present Examples then added, to 10 g of the surface-reformed Ba₂SiO₄:Eu²⁺, 30 g of polyvinyl alcohol (resin) dissolved in a mixed solution (300 g: solvent) of water:dimethyl sulfoxide with the ratio of 1:1, and stirred the resulting mixture in a dispersing device. This operation prepared an application liquid for forming a green fluorescent substance layer. The present Examples applied the thus prepared application liquid for forming a green fluorescent substance layer at a green pixel position on the CF-provided glass substrate by screen printing so that the resulting layer would have a width of 3 mm. The present Examples next heated the substrate in a vacuum oven (conditions: 200° C. and 10 mmHg) for 4 hours to dry it. This operation formed a red fluorescent substance layer.

The above process prepared (i) a fluorescent substance substrate on which a red fluorescent substance layer was provided and (ii) a fluorescent substance substrate on which a green fluorescent substance layer was provided.

(Assembly of Organic EL Component)

The present Examples aligned the organic EL section substrate and the fluorescent substance substrates, prepared as described above, with an alignment marker provided outside a pixel placement position. The present Examples applied a thermosetting resin to the fluorescent substance substrates before the alignment.

The present Examples, after the alignment, closely attached the two substrates to each other with the thermosetting resin in-between, and heated the product at 90° C. for 2 hours for curing. The present Examples carried out the step of attaching the two substrates to each other in a dry air environment (moisture content: −80° C.) in order to prevent the organic light-emitting unit 12 from degrading due to water.

The above process prepared an organic EL component corresponding to a red pixel (Example 1) and an organic EL component corresponding to a green pixel (Example 2).

The present Examples finally assembled an organic EL component 1, and connected, to an outside power supply, terminals provided along the periphery of the organic EL component.

### Comparative Example

The present Comparative Example prepared an organic EL component (blue organic EL component) by attaching an organic EL substrate, prepared similarly to the above Examples, to a glass substrate. The Comparative Example, similarly to the above Examples, used film thicknesses for a silver electrode serving as a translucent electrode which film thicknesses varied from 7 to 47 nm.

<Light Extraction Efficiency>

Measurements were made of outside quantum yields (at 10 mA/cm²) of light, actually extracted to the outside, of (i) the organic EL component 1 of Example 1 or 2 prepared as described above and (ii) the organic EL component of the Comparative Example. The measurements of the outside quantum yields were made with use of a fluorescence spectro-photometer with an integrating sphere attached thereto.

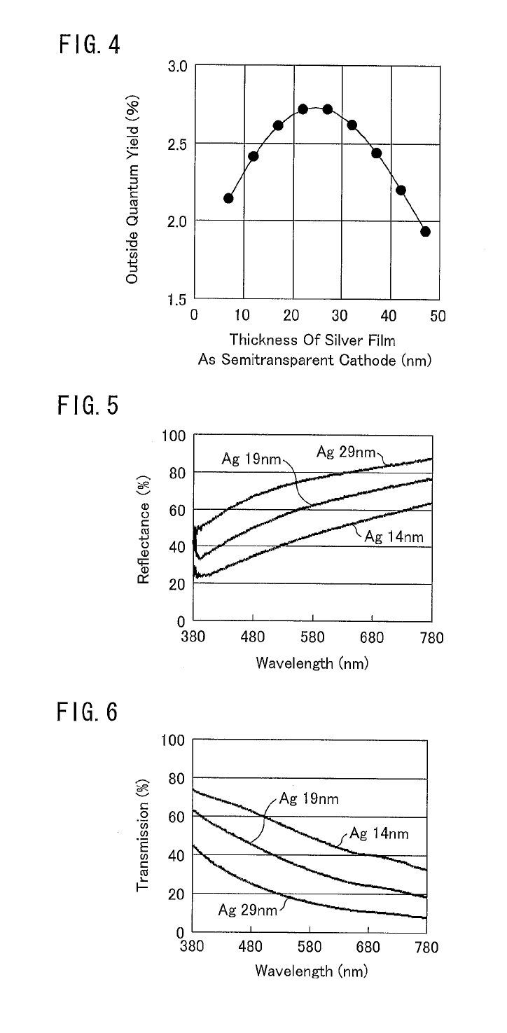

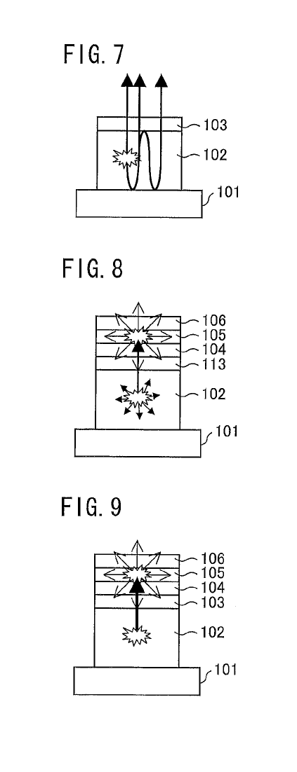

FIGS. 2 through 4 illustrate results of the measurements. FIG. 2 is a graph indicative of the relation, observed in the organic EL component (which included no color converting layer) of the Comparative Example, between the thickness of the silver film as a translucent electrode and the outside quantum yield. FIG. 3 is a graph indicative of the relation, observed in the organic EL component 1 (which included a red color converting layer) of Example 1, between the thickness of the silver film as a translucent electrode and the outside quantum yield. FIG. 4 is a graph indicative of the relation, observed in the organic EL component (which included a green color converting layer) of Example 2, between the thickness of the silver film as a translucent electrode and the outside quantum yield.

FIG. 2 indicates that the organic EL component (which included no color converting layer) of the Comparative Example achieved a maximum outside quantum yield when including, as a semitransparent cathode, a silver film having a thickness of less than 20 nm.

In contrast, FIGS. 3 and 4, each indicate that the organic EL components (each of which included a color converting layer) of Examples 1 and 2 each achieved a large outside quantum yield when including, as a semitransparent cathode, a silver film having a thickness of 20 nm or greater. Specifically, the outside quantum yield was large in the case where the silver film as a semitransparent cathode had a thickness of not less than 20 nm and not greater than 30 nm, particularly not less than 22 nm and not greater than 27 nm. The outside quantum yield was at its maximum in the case where the silver film as a semitransparent cathode had a thickness of around 25 nm.

The above observation clearly indicates that a preferable thickness of a translucent electrode of an organic EL component including a fluorescent substance layer is larger than a preferable thickness of a translucent electrode of an organic EL component including no fluorescent substance layer.

As described below, increasing the thickness of a translucent electrode increases reflectance of that translucent electrode. The organic EL component including a fluorescent substance layer is thus presumed to have caused its translucent electrode to reflect a portion of light isotropically scattered by the fluorescent substance layer which portion traveled in a direction opposite to a direction toward the light extraction side, with the result of a reduced light extraction loss.

An excessively large thickness for the translucent electrode, however, presumably prevented sufficient extraction of light emitted by the organic light-emitting unit, which resulted in a decrease in the overall outside quantum yield.

<Reflectance and Transmittance of Semitransparent Cathode>

Next, the film thickness of the semitransparent cathode of each of Examples 1 and 2 was varied and formed on separate glass substrates. Specifically, a LiF (thickness 0.5 nm) film as an electron injection layer was formed on a glass substrate, and a MgAg/Ag film was then formed on that LiF film as a semitransparent cathode. The ratio of Mg:Ag was 1:9. The MgAg/Ag film had a thickness of 1 nm. The thickness for Ag was varied as 14 nm, 19 nm, and 29 nm.

Measurements were made of reflectance and transmittance of each semitransparent cathode substrate prepared as described above. The reflectance and transmittance were determined by measuring, with use of a spectro photometer, a transmission spectrum of visible light having wavelengths of 380 nm to 780 nm.

FIGS. 5 and 6 illustrate results of the measurements of reflectance and transmittance, respectively. FIG. 5 is a graph indicative of the relation between the wavelength of light and reflectance. FIG. 6 is a graph indicative of the relation between the wavelength of light and transmittance.

As illustrated in FIG. 5, the reflectance was higher in the green range (in the vicinity of 520 nm) and the red range (in the vicinity of 620 nm) than in the blue range (in the vicinity of 450 nm). Specifically, the reflectance in the green range and the red range was 50% or greater, or even 60% or greater, with a Ag thickness ranging from 19 nm to 29 nm. The reflectance in the blue range was 60% or less with a Ag thickness ranging from 19 nm to 29 nm.

Further, as illustrated in FIG. 6, the transmittance was highest in the blue range (in the vicinity of 450 nm), and was 25% or less with a Ag thickness ranging from 19 nm to 29 nm.

In the case where the Ag thickness ranges from 19 nm to 29 nm, the semitransparent cathode has a thickness ranging from 20 nm to 30 nm.

The above results indicate that in the semitransparent cathode of each of the present Examples, adjusting the thickness of the silver film can increase (i) transmittance in the blue range and (ii) reflectance in the green range and the green red range.

The above results in turn indicate that preparing a display device with use of the organic EL component of the present embodiment enables production of a highly efficient display device that allows (i) blue light from an organic EL layer to reach a fluorescent substance layer efficiently and (ii) light emitted from a red fluorescent substance layer and a green fluorescent substance layer to be reflected by a semitransparent cathode efficiently.

Measurements similar to the above were made of reflectance and transmittance of the semitransparent cathode of each of the present Examples with respect to ultraviolet light (400 nm or less). The measurements produced results showing that with a Ag thickness ranging from 19 nm to 29 nm, the reflectance was 50% or less and the transmittance was 40% or greater.

The results of the measurements indicate that even in the case where a display device is prepared with use of an organic EL component including an organic light-emitting unit that emits ultraviolet light (400 nm or less), that display device is highly efficient as well. Such a display device can be used as a preferable display device because it can have an identical viewing angle characteristic for blue, red, and green.

### INDUSTRIAL APPLICABILITY

The present invention is suitably applicable to an organic EL display device.

### REFERENCE SIGNS LIST

1 organic EL component
11 first electrode
12 organic light-emitting unit
13 second electrode
14 sealing film
15 fluorescent substance layer
16 CF-provided substrate

1. An organic electroluminescent component comprising:
a pair of electrodes one of which is a translucent electrode;
an organic light-emitting unit sandwiched between the pair of electrodes; and
a color converting layer provided on a side of the translucent electrode which side is opposite to a side on which the organic light-emitting unit is provided, such that the translucent electrode is sandwiched between the color converting layer and the organic light-emitting unit,
the color converting layer (i) absorbing light emitted by the organic light-emitting unit and having a first color and (ii) emitting converted light having a second color different from the first color,
the translucent electrode including a metal compound and having a film thickness of not less than 20 nm and not greater than 30 nm.

2. The organic electroluminescent component according to claim 1,
wherein:
the pair of electrodes forms a microresonator structure.

3. The organic electroluminescent component according to claim 1,
wherein:
the translucent electrode has a film thickness of not less than 22 nm and not greater than 27 nm.

4. The organic electroluminescent component according to claim 1,
wherein:
the organic light-emitting unit emits blue or ultraviolet light; and
the translucent electrode has a reflectance of (i) not greater than 60% with respect to the blue or ultraviolet light and (ii) not less than 60% with respect to the converted light emitted by the color converting layer.

5. The organic electroluminescent component according to claim 1,
wherein:
the organic light-emitting unit emits ultraviolet light; and
the translucent electrode has a reflectance of (i) not greater than 50% with respect to the ultraviolet light and (ii) not less than 50% with respect to the converted light emitted by the color converting layer.

6. The organic electroluminescent component according to claim 1,
wherein:
the organic light-emitting unit emits blue or ultraviolet light; and
the translucent electrode has a transmittance of not less than 25% with respect to the blue or ultraviolet light.

7. The organic electroluminescent component according to claim 1,
wherein:
the organic light-emitting unit emits ultraviolet light; and
the translucent electrode has a transmittance of not less than 40% with respect to the ultraviolet light.

8. The organic electroluminescent component according to claim 1,
wherein:
the metal compound included in the translucent electrode is one of silver, a silver alloy, gold, and a gold alloy.

9. A display device comprising:
the organic electroluminescent component according to claim 1.

10. A display device comprising:
a plurality of arranged light-emitting elements including a red-light-emitting element, a green-light-emitting element, and a blue-light-emitting element,
the red-light-emitting element and the green-light-emitting element each including the organic electroluminescent component according to claim 1,
the blue-light-emitting element including a first organic electroluminescent component that is identical to the organic electroluminescent component according to claim 1 except that the color converting layer is absent in the first organic electroluminescent component,
the organic light-emitting unit in each of the plurality of arranged light-emitting elements emitting blue light,
the translucent electrode in each of the red-light-emitting element and the green-light-emitting element having a reflectance with respect to the converted light which reflectance is higher than a reflectance of the translucent electrode in the blue-light-emitting element with respect to the converted light.

11. The display device according to claim 10,
wherein:
the translucent electrode in the blue-light-emitting element has a transmittance with respect to the light emitted by the color converting layer which transmittance is higher than a transmittance of the translucent electrode in each of the red-light-emitting element and the green-light-emitting element with respect to the light emitted by the color converting layer.

12. The display device according to claim 10,
wherein:
the blue-light-emitting element includes a film thickness adjusting layer,
the film thickness adjusting layer being provided on a side of the translucent electrode which side is opposite to a side on which the organic light-emitting unit is provided, such that the translucent electrode is sandwiched between the film thickness adjusting layer and the organic light-emitting unit,
the film thickness adjusting layer including either (i) an inorganic material including silicon oxide, silicon nitride, or tantalum oxide or (ii) an organic material including a polyimide, an acrylic resin, or a resist material.

13. A display device comprising:
a plurality of arranged light-emitting elements including a red-light-emitting element, a green-light-emitting element, and a blue-light-emitting element,
the red-light-emitting element, the green-light-emitting element, and the blue-light-emitting element each including the organic electroluminescent component according to claim 1,
the organic light-emitting unit in each of the plurality of arranged light-emitting elements emitting ultraviolet light.

14. The display device according to claim 10,
wherein:
the plurality of arranged light-emitting elements include, in addition to the red-light-emitting element, the blue-light-emitting element, and the green-light-emitting element, at least one of a white-light-emitting element, a yellow-light-emitting element, a magenta-light-emitting element, and a cyan-light-emitting element.
